(19) United States
(12) Patent Application Publication
(10) Pub. No.: US 2003/0222916 A1
(43) Pub. Date: Dec. 4, 2003

(54) Object-oriented processing of tab text

(76) Inventors: Katie Kuwata, Oceanside, CA (US); William Su, El Monte, CA (US); Truc Nguyen, San Diego, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/157,525

(22) Filed: May 28, 2002

(51) Int. Cl. G09G 5/00

(52) U.S. Cl. 345/777; 715/500; 345/838

(57) ABSTRACT

An object-oriented processor for managing tab text information. The processor includes a data object and a view object. The data object is for storing data representative of the tab text, related attributes, and properties of the media on which the tab text is printed. The view object stores data representative of form and display control information for displaying the tab information in one of a single-line editable text format, a tab sheet thumbnail format or a readable text format.

### BACKGROUND OF THE INVENTION

This invention is related to an object-oriented approach of processing and editing tab text.

A tab, as is commonly known, is the protruding portion of, for example, a sheet of paper that typically extends beyond the general outline of the paper medium to facilitate an indexing function. A tab sheet manufactured to include the tab is used as a document separator in a document compilation to mark the beginning of a section or chapter that comprises the compilation of multiple pages of similar print medium. The tab is usually printed with an alphanumeric text caption to facilitate searching by a user for the section of interest in the compilation.

One conventional method for generating tab information requires the user to utilize an advanced word processing program to create a text box, and to position the text box where the user wants the tab text to appear on the tab document to be printed. Thus the user first needs to estimate the position of the tab index on the page, position the text box, select the font and size, modify the orientation for the text, enter the text, and finally, adjust the position of the text. Consequently, such a conventional tab management architecture involves many steps that are time-consuming, and furthermore, the tab information cannot be modified or re-positioned easily, if desired, at a later time.

What is needed is a more efficient and user-friendly method for managing tab generation and editing.

### SUMMARY OF THE INVENTION

The present invention disclosed and claimed herein, in one aspect thereof, comprises an object-oriented processor for managing tab text information. The processor includes a data object and a view object. The data object is for storing data representative of the tab text, related attributes, and properties of the media on which the tab text is printed. The view object stores data representative of form and display control information for displaying the tab information in one of a single-line editable text format, a tab sheet thumbnail format or a readable text format.

### BRIEF DESCRIPTION OF THE DRAWINGS

For a more complete understanding of the present invention and the advantages thereof, reference is now made to the following description taken in conjunction with the accompanying drawing, in which:

FIG. 1 illustrates a block diagram of the software object relationship in an operating system context, according to a disclosed embodiment;

FIG. 2 illustrates a user interface screenshot of the line view provided by the view object, according to a disclosed embodiment;

FIG. 3 illustrates a screenshot of a thumbnail view of multiple pages, according to a disclosed embodiment; and

FIG. 4 illustrates a portion of a full page view.

### DETAILED DESCRIPTION OF THE INVENTION

The disclosed architecture solves this problem by providing an object-oriented architecture for tab management by creating an algorithm that processes tab information that is structured as one or more self-organized objects. The algorithm also provides a user interface that allows a user to generate tab information that can easily be managed through a number of processes, including editing, inserting, deleting, copying, etc., all processes that are similar to the way in which text is handled in a standard word processor application.

The object-oriented nature of the disclosed architecture provides independent program modules written in an XML (eXtensible Markup Language) format that work together as a group at runtime without any prior linking or precompilation. Thus the objects interoperate strictly through messages passed between them.

A further aspect of the architecture is that a grouping of already-defined tab captions can be cut, copied, or pasted to another group of tab captions.

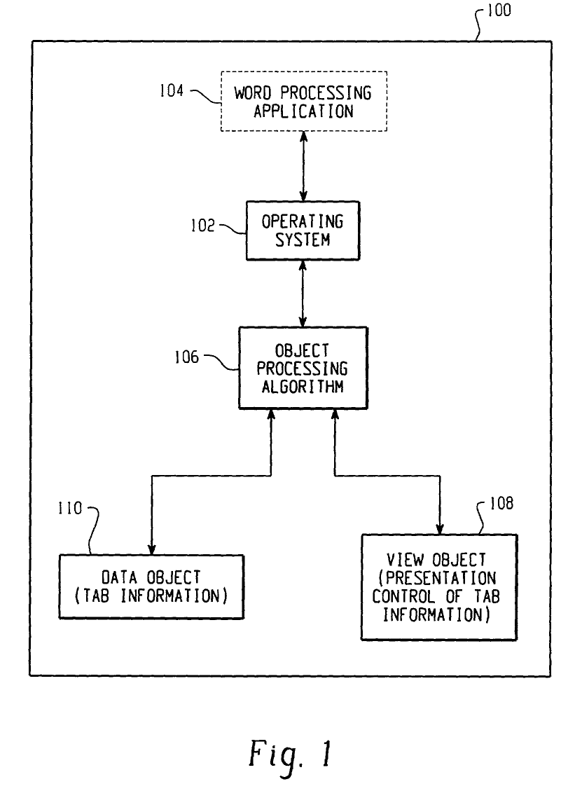

Referring now to FIG. 1, there is illustrated a block diagram of the software object relationship in an operating system context, according to a disclosed embodiment. In this particular embodiment, a printer controller system 100 includes an operating system 102 for operation of the system 100 across a network, or local to a user client. Where the object-based architecture is resident in a client computer (thick or thin) as an embodiment of system 100, the system 100 can include one or more applications, e.g., a word processing application 104 with which to utilize the features of the disclosed architecture. In either case, the user invokes the tab text printing features, e.g., within a browser, whether operating from the client system or the printer controller system 100. The system 100 also includes a software algorithm 106 that defines the behavior of the tab processing within the system 100 by performing object processing with a view model (or object) 108 and a data model (or object) 110. The code of the software algorithm 106 defines the system behavior during processing and editing of the tab objects.

The view model 108 incorporates various forms and display controls for displaying the tab information in a single-line editable-text format, or tab sheet thumbnail format, or readable-text format, all of which are illustrated hereinbelow.

The data object 110 includes the tab text, related tab attributes, and properties of the tab paper (used in, for example, a printer controller from which the tab sheet will be printed), all of which are encoded in an XML language format. The tab attributes include the text font name and size, the orientation and layout of the text in the tab area, the tab position on the tab sheet, and the position of the tab sheet in the overall document compilation.

The disclosed object architecture is implemented as a set of XML files that identify both the structure and the order of the tab text, as well as the properties of the tab paper on which the tab text is printed.

The user invokes the tab features to enter or review tab text. When the features are invoked, the user is presented with a dialog that prompts the user for options. When the document is to be printed, the user need only ensure that tab paper is in the peripheral output device (i.e., the printer controller).

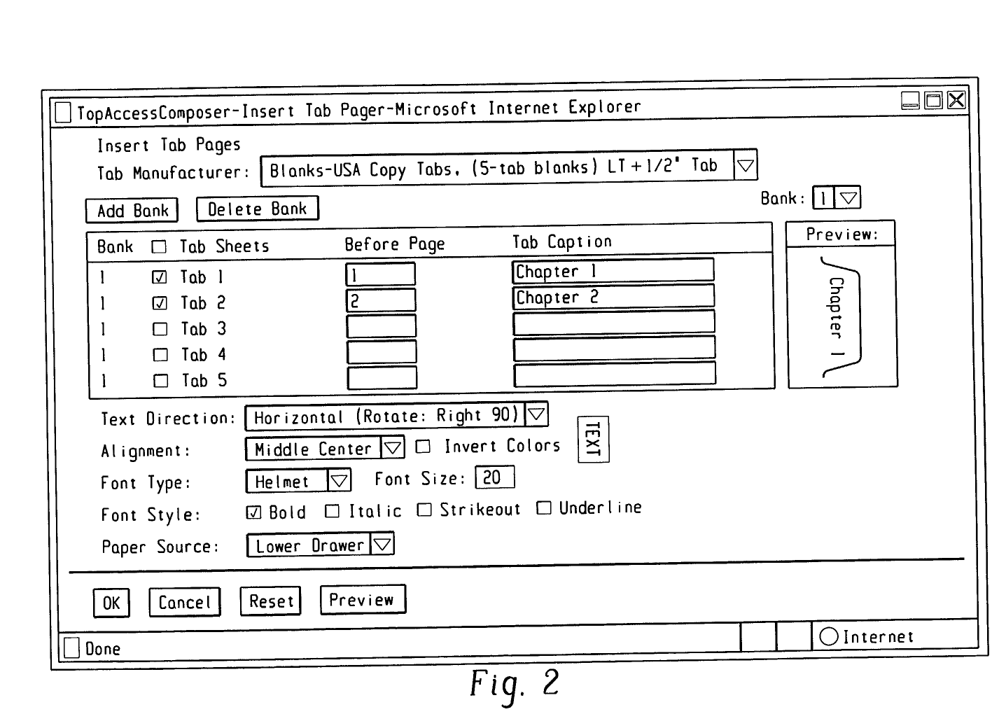

Referring now to FIG. 2, there is illustrated a user interface screenshot of the line view provided by the view object, according to a disclosed embodiment. To create a tab, the user selects a menu option denoted Tab Set/New to define a collection of tab sheets as a tab object. The properties of each tab sheet of the collection can be changed by invoking a Tab Paper Properties selection. The Tab Paper Properties menu selection allows the user to modify the number of tabs per sheet, the tab dimensions, and the print properties of the tab text, i.e., font name, font size, and text orientation.

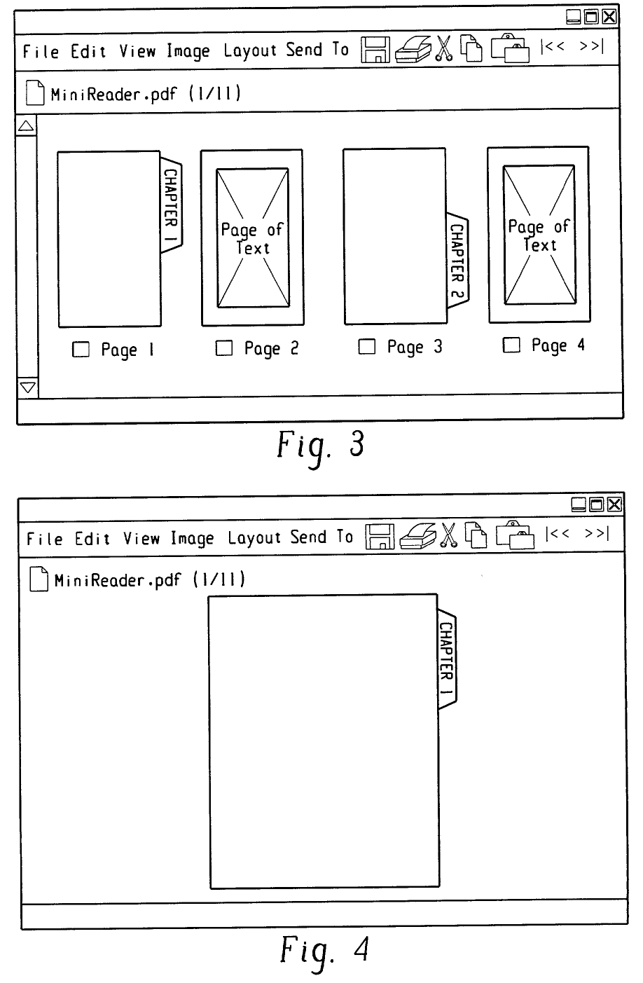

If the user selects a List View option, the text of all the corresponding tabs is displayed in a editable line-by-line list. If the user chooses a Thumbnail View selection, the tab text is displayed as small text in a protruding portion of the tab sheet thumbnail form. FIG. 3 illustrates a screenshot of a thumbnail view of multiple pages, according to a disclosed embodiment. If the user chooses a Readable View selection, the tab text is displayed in a large tab sheet form. FIG. 4 illustrates a portion of a full page view when the Readable View selection is made.

Continuing with the description of FIG. 2, the user then enters the tab caption in the order of the tab position. A blank entry indicates that no tab text is defined for that particular tab position. The tab positions are associated with the number of tabs per tab sheet, and then automatically wrap around to the first position of the next tab set. For example, if the paper is a first set of 5-tab paper, text captions 1-5 are positioned for the five tabs in the first set, and text caption 6 is positioned for the first tab in the next (or second) set of tab paper.

To save the tab information and layout, the user chooses a Tab Set/Save or File/Save selection. The tabs data and associated tab properties are then saved to a data file in the XML format.

To copy a tab caption, the user selects the one or more tabs to be copied by placing a check mark in a location associated with the tab. The user then chooses an Edit/Copy selection to copy the tabs. The data of the check-marked tabs and associated properties are saved to a temporary clipboard file in the XML format.

To insert a new tab, the user positions the cursor at the place where the new tab is to be inserted, and chooses an Insert New Tab selection to insert a blank new tab. A blank tab is then inserted, and the view is updated. The user then enters caption text for the new tab.

To delete a tab caption, the user selects one or more tabs to be deleted (or cut) by placing a check mark in a field associated with each tab. The user then chooses an Edit/Delete selection to delete the tabs. The tab data and associated properties information are then deleted from the data object 110 and the view object 108 is updated accordingly.

To move a tab caption, the user selects the one or more tabs to be moved by placing a check mark in a field associated with each tab, and chooses an Edit/Cut selection to remove the tabs. The data and associated properties information of the cut tabs are then saved to a temporary clipboard file in an XML format. The user then positions the cursor at the destination where the information is to be moved, and chooses an Edit/Paste selection to copy the tab information from the clipboard to the destination.

The following example XML code specifies a tab information source file, the source file location, tab text properties, and tab text orientation for placement on the tab paper.

<tabfile>/pbtemp/tab/tab 1.png</tabfile>

<tabsource>LC</tabsource>

<tableft>4992</tableft>

<tabtop>100</tabtop>

<tabheight>100</tabheight>

<tabwidth>20</tabwidth>

<tabfontname>Arial</tabfontname>

<tabfontsize>12</tabfontsize>

<taborientation>horizontal</taborientation >

The following sample XML code specifies the tab orientation and text for various chapter tab sheets in a compilation.

<tabinfo>

<orientation>PORTRAIT</orientation>

<tabtext>Introduction</tabtext>

<tabtext>Chapter 1</tabtext>

<tabtext>Chapter 2</tabtext>

<tabtext>Chapter 10</tabtext>

</tab>

</tabinfo>

Although the preferred embodiment has been described in detail, it should be understood that various changes, substitutions, and alterations can be made therein without departing from the spirit and scope of the invention as defined by the appended claims.

What is claimed is:

1. An object-oriented method of managing tab text, comprising the steps of:
inputting tab information into a data object;
displaying the tab information with a view object; and
controlling behavior of the data object and the view object with an object processing algorithm.

2. The method of claim 1, wherein the tab information of the data object in the step of inputting includes data representative of at least one of tab text, attributes of the tab text, and properties of a tab sheet on which the tab text is applied.

3. The method of claim 2, wherein the attributes of the tab text include at least one of a font name, font size, font orientation, font layout, position of the tab text on the tab sheet, and position of the tab sheet in a document compilation.

4. The method of claim 1, wherein the view object in the step of displaying includes data representative of at least one of form control information of a document and display control information of the document.

5. The method of claim 4, wherein the form control information and the display control information facilitate the display of the tab information in at least one of a single-line editable text format, a tab sheet thumbnail format, and a readable text format.

6. The method of claim 1, wherein at least one of the data object, view object, and the object processing algorithm is written in XML.

7. The method of claim 1, wherein the data object, view object, and object processing software operate from at least one of a client computer system and a printer controller.

8. An object-oriented architecture of managing tab text, comprising:
a data object for receiving tab information;
a view object for displaying the tab information; and
an object processing algorithm for controlling behavior of the data object and the view object.

9. The architecture of claim 8, wherein the tab information of the data object includes data representative of at least one of tab text, attributes of the tab text, and properties of a tab sheet on which the tab text is applied.

10. The architecture of claim 9, wherein the attributes of the tab text include at least one of a font name, font size, font orientation, font layout, position of the tab text on the tab sheet, and position of the tab sheet in a document compilation.

11. The architecture of claim 8, wherein the view object includes data representative of at least one of form control information of a document and display control information of the document.

12. The architecture of claim 11, wherein the form control information and the display control information facilitate display of the tab information in at least one of a single-line editable text format, a tab sheet thumbnail format, and a readable text format.

13. The architecture of claim 8, wherein at least one of the data object, view object, and the object processing algorithm is written in XML.

14. The architecture of claim 8, wherein the data object, view object, and object processing software operate from at least one of a client computer system and a printer controller.
